(19) United States
(12) Patent Application Publication
(10) Pub. No.: US 2025/0358793 A1
(43) Pub. Date: Nov. 20, 2025

(54) WIRELESS NETWORK BANDWIDTH CONTROL

(71) Applicant: Charter Communications Operating, LLC, St. Louis, MO (US)

(72) Inventor: Dileep Kumar Soma, Denver, CO (US)

(21) Appl. No.: 18/666,253

(22) Filed: May 16, 2024

(51) Int. Cl. H04W 72/04; H04W 72/52

(52) U.S. Cl. CPC H04W 72/04; H04W 72/52

(57) ABSTRACT

A network environment includes a wireless access point supporting network access to multiple mobile communication devices. A communication management resource associated with the wireless access point receives a first communication from a first communication device. The first communication includes a first request for wireless bandwidth. The communication management resource compares a magnitude of current wireless bandwidth supplied to the first communication device to a bandwidth request value as indicated by the first request for the first wireless bandwidth. The communication management resource adjusts the magnitude of the current wireless bandwidth supplied to the first communication device depending on the comparison.

### BACKGROUND

Wi-Fi™ technology implements so-called transmit opportunities (TXOPs) in which a wireless station is able to wirelessly transmit data after acquiring use of a wireless channel. For example, a transmit opportunity (a.k.a., TXOP) is a MAC (Media Access Control) layer feature used in IEEE 802.11-based wireless local area network (WLAN). A so-called TXOP defines the time duration for which a station can send frames of data after it has acquired rights in the wireless channel via a so-called listen before talk function.

### BRIEF DESCRIPTION OF EXAMPLES

This disclosure includes the observation that conventional techniques of controlling allocation of wireless bandwidth to multiple communication devices suffer from deficiencies. For example, conventional wireless systems do not always provide unrestricted and continuous network access to communication devices, especially in congested network environments where multiple communication devices compete for use of limited wireless bandwidth. Techniques herein include providing better wireless connectivity performance to communication devices across different environmental conditions.

More specifically, the wireless system as discussed herein can be configured to include any number of wireless stations such as a wireless access point and one or more mobile communication devices. Via wireless connectivity provided by the wireless access point, the one or more mobile communication devices are able to communicate through the wireless access point with one or more entities in a remote network.

Operations of a wireless access point can be controlled by a communication management resource (communication management hardware, communication management software, or a combination of communication manager hardware and communication management software).

As discussed herein, the communication management resource associated with the wireless access point can be configured to: receive a first communication from a first communication device, the first communication including a first request for first wireless bandwidth; compare a magnitude of current wireless bandwidth supplied to the first communication device to a bandwidth request value as indicated by the first request for the first wireless bandwidth; and adjust the magnitude of the current wireless bandwidth supplied to the first communication device based on the comparison.

In one example, adjustment of the magnitude of the current wireless bandwidth supplied to the first communication device includes: via a first control loop implemented by the communication management resource, iteratively adjusting the magnitude of second wireless bandwidth allocated to support wireless connectivity between the wireless access point and a second mobile communication device. Note that the iterative adjustment of the magnitude of the second wireless bandwidth may include: iteratively reducing a magnitude of the second wireless bandwidth; and using freed up bandwidth associated with the reduction of the magnitude of the second wireless bandwidth to support an increase in the first wireless bandwidth provided to the first communication device.

In accordance with further examples, the communication management resource can be configured to: in response to detecting that the magnitude of the current wireless bandwidth is less than the bandwidth request value, adjust a queue priority level of storing data packets in multiple queues, the store data packets destined for delivery to the first communication device. In one example, the adjusted to priority level of storing the data packets destined for delivery to the first communication device increases a magnitude of the wireless bandwidth to be greater than a magnitude of the bandwidth request value.

In accordance with yet further examples as discussed herein, the communication management resource can be configured to receive the first bandwidth request value in an action frame of the first communication.

Still further examples as discussed herein include the communication management resource receiving the first communication indicating the bandwidth request value over a first wireless communication link from the first communication device. Via the first wireless bandwidth, the wireless access point and corresponding communication management resource provide the first communication device access through the wireless access point to a remote network.

In accordance with another example as discussed herein, the communication management resource associated with the wireless access point determines that the first communication device is assigned a first priority level based on a unique identifier value assigned to the first communication device. The communication management resource and corresponding wireless access point increase a magnitude of the current wireless bandwidth supplied to the first communication device in response to detecting that the first priority level assigned to the first communication device is higher than a second priority level assigned to a second communication device provided wireless access through the wireless access point. In one example, the increased magnitude of the current wireless bandwidth supplied to the first communication device is achieved by reducing a magnitude of bandwidth supplied to the second communication device through the wireless access point.

Yet further, adjusting the magnitude of the current wireless bandwidth supplied to the first communication device may include using freed up bandwidth associated with the reduction of the magnitude of the second wireless bandwidth to support an increase in the first wireless bandwidth.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable storage hardware (such as hardware to store executable instructions), or non-transitory computer-readable storage media, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage hardware medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, examples herein are directed to a method, system, computer program product, etc., that supports operations as discussed herein.

One example as discussed herein includes a computer readable storage medium and/or system having instructions stored thereon to facilitate better use of available wireless resources. The instructions, when executed by computer processor hardware, cause the computer processor hardware (such as one or more co-located or disparately processor devices or hardware) to: receive a first communication from a first communication device, the first communication including a first request for first wireless bandwidth; compare a magnitude of current wireless bandwidth supplied to the first communication device to a bandwidth request value as indicated by the first request for the first wireless bandwidth; and adjust the magnitude of the current wireless bandwidth supplied to the first communication device based on the comparison.

Note that the ordering of the steps above has been added for clarity sake. Further note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless communication services. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment and multiple wireless stations negotiating use of wireless bandwidth provided by a wireless access point in a wireless network environment as discussed herein.

FIG. 2 is an example diagram illustrating communication of bandwidth request information via out of band communication as discussed herein.

FIG. 3 is an example diagram illustrating use of an action frame to provide notification of bandwidth request information as discussed herein.

FIG. 4 is an example diagram illustrating implementation of multiple queues to control conveyance of downlink data from the wireless access point to multiple communication devices as discussed herein.

FIG. 5 is an example diagram illustrating a flowchart of controlling bandwidth allocation to multiple communication devices as discussed herein.

FIG. 6 is an example diagram illustrating implementation of a communication management resource to adjust communication of data packets to multiple communication devices as discussed herein.

FIG. 7 is an example diagram illustrating implementation of first level data packet dropping associated with communicating data in a downlink to one or more communication devices to provide increased bandwidth to a higher priority communication device as discussed herein.

FIG. 8 is an example diagram illustrating implementation of second level data packet dropping associated with communicating data in a downlink to one or more communication devices to provide increased bandwidth to a higher priority communication device as discussed herein.

FIG. 9 is an example diagram illustrating example computer architecture operable to execute one or more operations as discussed herein.

FIG. 10 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

A network environment includes a wireless access point supporting network access to multiple mobile communication devices. A communication management resource associated with the wireless access point receives a first communication from a first communication device. The first communication includes a first request for wireless bandwidth. The communication management resource compares a magnitude of current wireless bandwidth supplied to the first communication device to a bandwidth request value as indicated by the first request for the first wireless bandwidth. The communication management resource adjusts the magnitude of the current wireless bandwidth supplied to the first communication device based on the comparison.

The solution as discussed herein includes bandwidth negotiation between the wireless access point and client device (mobile communication device) such as at or during the first hop of communication. The first hop communication may be defined as the operation where the mobile communication device communicates with the wireless access point over a wireless medium (a.k.a., wireless communication link) using 802.11 protocols (Wi-Fi communication). To transmit the bandwidth request information from the mobile communication device, the mobile communication device implements a listen before talk function to acquire a respective wireless channel and then communicates the bandwidth request information over that channel to the wireless access point.

In one example, the operation of the mobile communication device connecting with the wireless access point and negotiating allocation of bandwidth from the wireless access point includes one or more operations such as:
The wireless access point sends one or more communications to advertise its capabilities and uses vendor specific bits (defined as vendor specific bits in the 802.11 standard) in a wireless beacon to advertise itself as a router device associated with a particular service provider.
The mobile communication device (such as a client device) monitors the wireless communication link and processes the vendor specific bits in the received beacon from the wireless access point and responds in the initial association/probe request frames conveying the type, make and model of the mobile communication device using vendor defined bits
The bandwidth requirement communication received from the mobile communication device can occur in any suitable manner.

In one example, the mobile communication device implements so-called out of band communications such as Bluetooth or Ultra Wide Bandwidth (UWB) or other suitable wireless communication protocol to communicate with the wireless access point.

In another example, the communication device implements a so-called notification of bandwidth requirements to the wireless access point via use of an in-band action frame communication: Using 802.11 action frames for communicating bandwidth requirement on a regular basis to the router. The wireless access point AP responds with confirmation in the same medium bandwidth as used to receive the information in the action frame.
Bandwidth management: the wireless access point manages allocation of wireless bandwidth such that the mobile communication device is served downlink wireless communications with requested bandwidth by moderating other device traffic from the wireless access point to other mobile communication devices.
After the wireless access point receives the bandwidth requirement information from the mobile communication device, the wireless access point ensures that the mobile communication device is provided the requested bandwidth in any number of ways.

The wireless access point can be configured to manage the air-time (duration time supporting downlink communications) allocated to the client devices by implementing a flow control algorithm.

If the wireless access point determines that the client device is not receiving the requested bandwidth and senses that other client device communications are causing congestion, the wireless access point implements bandwidth adjustments to each of the different mobile communication devices such that the mobile communication device is provided with appropriate downlink bandwidth.

If current client device contention is the issue, the wireless access point can be configured to implement one or more of the following operations to provide the mobile communication device appropriate wireless bandwidth.

Flow control as discussed herein may include queue management to prioritize sending uplink packets coming from the subscriber communication devices associated with a particular service provider over other packets to the backend network and prioritize sending downlink packets to the subscriber communication devices.

If the Queue management operation as discussed herein still doesn't provide requested bandwidth to the mobile communication device, the wireless access point and corresponding communication management resource can be configured to drop one or more TCP packets of other competing device communications as TCP lowers its bandwidth based on packet Error rate (PER). This new released bandwidth can be utilized by the communication device requesting bandwidth at a particular level.

In one example, the wireless access point and corresponding communication management resource drops TCP packets only up to a threshold value such as 25% or other suitable amount such that the reduced bandwidth to the non-subscriber communication devices does not cause disconnection for those devices. If desired, the wireless access point can be configured to implement the same operations for nonsubscribers in UDP communications until the appropriate bandwidth is provided to the requesting subscriber mobile communication device.

Yet further, as discussed herein, a communication system can be configured to support one or more functions such as: i) re-purpose existing action frames for bandwidth requirement communication, ii) implement queue management to meet bandwidth requirement associated with conveyance of data packets, iii) provide data packet control such as dropping of data packets to provide bandwidth management, and iv) implement one or more iterative loop functions to control bandwidth levels to different mobile communication devices, etc.

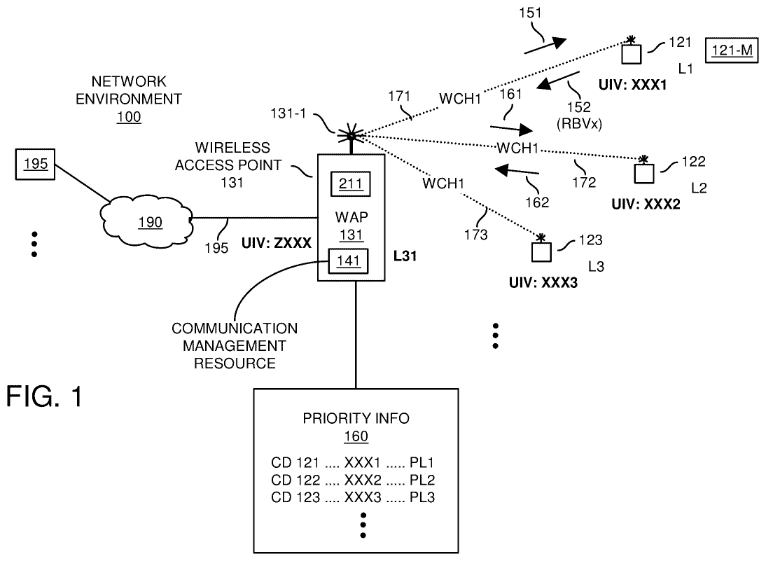

Now, more specifically, with reference to the drawings, FIG. 1 is an example diagram illustrating a network environment and multiple wireless stations negotiating use of a wireless bandwidth provided by a wireless access point in a wireless network environment as discussed herein.

As shown, network environment 100 includes server resource 195, network 190, wireless access point 131 (i.e., a wireless station), and one or more instances of user equipment such as mobile communication device 121 (i.e., a wireless station), mobile communication device 122, mobile communication device 123, etc.

Network environment 100 includes any number of wireless access points and any number of corresponding mobile communication devices.

As further shown, wireless network environment 100 or wireless access point 131 further includes communication management resource 141. The communication management resource 141 and the wireless access point 131 may be co-located or disparately located.

Note that the communication management resource 141 can be configured to execute operations or any of the functionality as described herein associated with the wireless access point 131 (such as a first wireless station) to allocate bandwidth to different mobile communication devices in the network environment 100.

Note further that each of the resources in network environment 100 can be configured to include or be configured as appropriate hardware, software, or combination of hardware and software to carry out respective operations as discussed herein.

For example, the communication management resource 141 as described herein can be implemented via respective communication management hardware, communication management software, or a combination of communication management hardware and communication management software; the wireless access point 131 as described herein can be implemented via respective wireless access point hardware, wireless access point software, or a combination of wireless access point hardware and wireless access point software; communication device 121 can be implemented via communication device hardware, communication device software, or a combination of communication device hardware and communication device software; communication device 122 can be implemented via communication device hardware, communication device software, or a combination of communication device hardware and communication device software; and so on.

Further in this example, each of the wireless stations is assigned a respective unique identifier value (such as network address for routing purposes) supporting communication of wireless messages. For example, wireless access point 131 (wireless station) at location L31 is assigned unique identifier value ZXXX; communication device 121 at location L1 is assigned unique identifier value XXX1; communication device 122 at location L2 is assigned unique identifier value XXX2; communication device 123 at location L3 is assigned unique identifier value XXX3; and so on.

As further shown, each of the wireless access points such as including wireless access point 131 in network environment 100 includes respective one or more instances of antenna hardware to wirelessly communicate directly with mobile communication devices (a.k.a., user equipment).

For example, the wireless access point 131 includes one or more instances of antenna hardware 131-1 (such as one or more antenna elements). Note that different sets of the antenna elements associated with the antenna hardware 131-1 can be configured to support different beamforming to transmit first wireless communications and receive second wireless communications in the network environment 100.

The wireless stations such as mobile communication device 121, mobile communication device 122, wireless access point 131, etc., support any of one or more wireless communications (or wireless communication protocols such as Wi-Fi™ or other suitable protocol) in one or more wireless frequency bands (unlicensed or licensed bands) such as 2.4 GHz (2.4 to 2.5 GHz), 5 GHz (5.1 to 5.9 GHZ), and/or 6 GHz (5.9 to 7.1 GHz). Further in this example, the wireless access point 131 implements antenna hardware 131-1 to transmit wireless signals 151 (such as one or more communications or messages over time) to the mobile communication device 121 at location L1. The wireless access point 131 implements antenna hardware 131-1 to receive wireless signals 152 (such as one or more communications or messages over time) transmitted from the mobile communication device 121.

Yet further in this example, the wireless access point 131 and mobile communication device 121 establish wireless communication link 171 between the wireless access point 131 and the mobile communication device 121. Via wireless communications 151, the wireless access point 131 communicates messages (such as one or more data packets) over wireless channel WCH1 in the downlink direction to the mobile communication device 121. Further, the mobile communication device 121 transmits wireless communications 152 over the wireless channel WCH1 in the uplink direction to the wireless access point 131.

Thus, via the communications 151 and communications 152, the wireless access point 131 provides the mobile communication device 121 access to the remote network 190 and any of one or more server resources 195 as it moves about different locations of the respective network environment 100. Thus, as its name suggests, the mobile communication device 121 (a.k.a., wireless station) can be configured to move around the network environment 100.

Still further, note that each of the wireless stations (wireless access point 131, mobile communication device 121, mobile communication device 122, etc.) in the network environment 100 can be configured to implement a respective clear channel assessment function (a.k.a., listen before talk access function) prior to wirelessly transmitting communications in the network environment 100.

For example, the wireless access point 131 can be configured to implement a listen before talk function (clear channel assessment function) in which the wireless access point 131 needs to acquire the wireless channel WCH1 before it is allowed to communicate the communications 151 in the downlink direction from the wireless access point 131 to the mobile communication device 121. Acquisition of the wireless channel WCH1 (such as a detected energy of the wireless channel below a threshold level for a time duration of a contention window) by the wireless access point 131 may include the wireless access point 131 detecting that a power level of wireless signals transmitted in the wireless channel WCH1 or corresponding wireless channel of interest is below a threshold level for a listen before talk time duration. If the detected wireless power level is greater than a threshold level for the listen before talk time duration, there is no channel acquisition and the wireless access point 131 waits until a respective next time slot or time to listen again to acquire the wireless channel WCH1.

In a similar manner, the mobile communication device 121 can be configured to implement a listen before talk function (clear channel assessment function) in which the mobile communication device 121 needs to acquire the wireless channel WCH1 before it is allowed to communicate the communications 152 in the uplink direction to the wireless access point 131. Acquisition of the wireless channel WCH1 by the mobile communication device 121 may include the mobile communication device 121 detecting that a power level of wireless signals transmitted in the wireless channel WCH1 or corresponding wireless channel of interest is below a threshold level for a listen before talk time duration. If the detected wireless power level is greater than a threshold level for the listen before talk time duration, there is no channel acquisition and the wireless station 121 waits until a respective next time slot or time to listen again to acquire the wireless channel WCH1.

Thus, each of the wireless stations in the network environment 100 can be configured to implement a respective clear channel assessment prior to transmitting communications in the network environment 100.

In a similar manner, each of multiple wireless stations (such as wireless access points, wireless base station, mobile communication devices, etc.) in the network by 100 can be configured to implement listen before talk functions to acquire a respective wireless channel to transmit corresponding wireless communications. Thus, the wireless stations such as wireless access point 131, mobile communication device 121, mobile communication device 122, mobile communication device 122, etc., can be configured to compete amongst each other to acquire use of the respective wireless channel WCH1.

As further discussed below, the communication management resource 141 can be configured to implement one or more different quality of service queues 211 to control delivery of data packets over the wireless communication link 171.

More specifically, via the wireless communication link 171, the wireless access point 131 transmits wireless communications over the wireless communication link 171 to the mobile communication device 121. Via the current wireless bandwidth allocated to the mobile communication device 121, the communication management resource 141 schedules downlink communications (151) over the wireless communication link 171 to provide the first communication device 121 network access through the wireless access point 131. As shown, the antenna hardware 131-1 supports receipt of communications from the mobile communication device 121. Additionally, the antenna hardware 131-1 supports transmission of wireless communications 151 from the wireless access point 131 over the wireless communication link 171 to the mobile communication device 121.

Further, via communications 152, the communication management resource 141 receives a first communication (instance of communication 152) transmitted from the first communication device 121 over the wireless communication link 171 to the wireless access point 131 and corresponding communication management resource 141. The first communication includes a first request for first wireless bandwidth to support access through the wireless access point 131 to the remote network 190. The communication management resource 141 compares a magnitude of current wireless bandwidth supplied by the wireless access point 131 to a bandwidth request value (such as received RBVx where x=1 in the communications 152) as indicated by the first request for the first wireless bandwidth. The communication management resource 141 determines from the priority information 160 that the communication device 121 is to be provided a highest priority PL1 in a priority hierarchy. For example, PL1 is the highest ranked priority in the priority hierarchy; PL2 is the next highest ranked priority in the priority hierarchy hierarch the; PL3 is the next highest ranked priority in the priority hierarchy; and so on, in the priority hierarchy.

As indicated by the priority information 160, wireless services provided by the wireless access point 131 ranked in accordance with different priority levels.

For example, as indicated by the priority information 160, the mobile communication device 121 assigned unique identifier value XXX1 (such as a network address or other value) is assigned a highest priority level PL1; the mobile communication device 122 assigned unique identifier value XXX2 (such as a network address or other value) is assigned a next lower priority level PL2; the mobile communication device 123 assigned unique identifier value XXX3 (such as a network address or other value) is assigned a lower priority level PL3; and so on.

In such an instance, because the communication device 121 and corresponding user operating the communication device 121 are assigned the highest priority level PL1 in the hierarchy (PL1, PL2, PL3, etc.), the communication management resource 141 provides the mobile communication device 121 the requested amount of wireless bandwidth in the downlink from the wireless access point 131 to the mobile communication device 121 as requested by RBVx received from the mobile communication device 121.

In the above example, when the current wireless bandwidth provided in the downlink from the wireless access point 131 over the wireless communication link 171 to the mobile communication device 121 is less than the magnitude of wireless bandwidth as specified by the received bandwidth request value RBVx, the communication management resource 141 adjusts a magnitude of the current wireless bandwidth supplied to the communication device 121 based on the comparison. Adjustment of the magnitude of the current wireless bandwidth provided over the wireless communication link 171 to the mobile communication device 121 may include the communication management resource 141 using freed up bandwidth associated with the reduction of a magnitude of the second wireless bandwidth supplied to the second mobile communication device to support an increase in the downlink wireless bandwidth allocated to convey communications 151 (one or more data packets) over the communication link 171 to the mobile communication device 121.

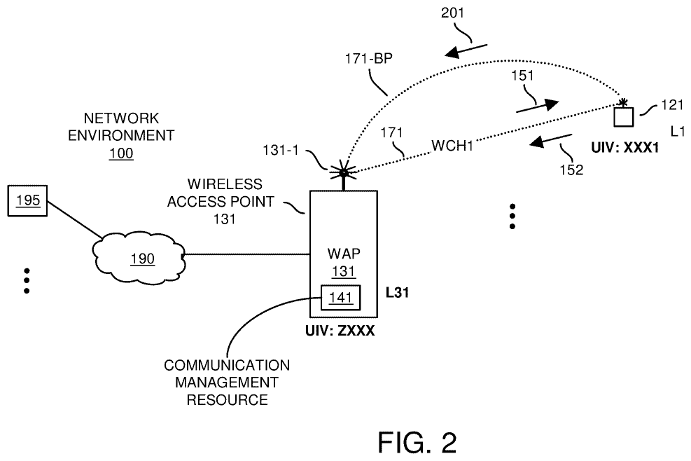

FIG. 2 is an example diagram illustrating communication of bandwidth request information via an out of band communication as discussed herein.

As previously discussed, the mobile communication device 121 can be configured to provide notification (such as a message 151 and RBVx) of a desired magnitude of wireless bandwidth requested for use by the wireless access point 131 to communicate respective data packets (data) over the wireless communication link 171 to the mobile communication device 121.

Note that the communication system as discussed herein can be configured to support so-called out of band communications between the mobile communication device 121 and the wireless access point 131. For example, the mobile communication device 121 can be configured to support a bypass (or supplemental) wireless communication link 171-BP providing supplemental wireless connectivity between the mobile communication device 121 and the wireless access point 131.

The wireless communication link 171-BP can be used for any suitable purpose. In one example, the wireless communication link 171-BP supports conveyance of the communications 201 from the mobile communication device 121 to the wireless access point 131. In this example, the communications 201 can be configured to include notifications of one or more bandwidth request values generated by the mobile communication device 121 over time. As previously discussed, each bandwidth request value received from the communication device 121 can be configured to indicate a desired wireless bandwidth of supporting wireless communications from the wireless access point 131 over the wireless communication link 171 (wireless channel WCH1) to the mobile communication device 121.

Further, as previously discussed, the amount of wireless bandwidth allocated to the mobile communication device 121 by the communication management resource 141 may be contingent upon a priority level associated with the mobile communication device 121 itself or a priority level assigned to the corresponding operator of the mobile communication device 121.

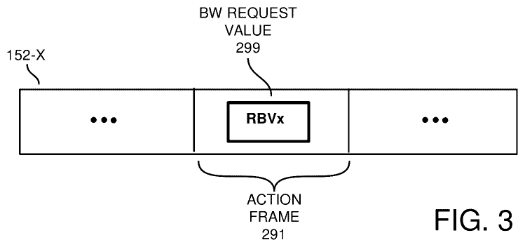

FIG. 3 is an example diagram illustrating use of an action frame to provide notification of bandwidth request information as discussed herein.

As previously discussed, the communication device 121 can be configured to transmit communications 152 over the wireless communication link 171 from the wireless access point 131. In one example, the communications include notification of a magnitude of requested wireless bandwidth RBVx to be provided by the wireless communication link 171 and corresponding wireless channel WCH1 in the uplink or the downlink.

As shown in FIG. 3, the example communication 152-X communicated from the mobile communication device 121 to the wireless access point 131 and corresponding communication management resource includes a so-called action frame 291. In one example, the action frame 291 is a management frame associated with Wi-Fi™ or other wireless communication protocol. The action frame 291 triggers an action such as bandwidth control associated with the wireless communication link 171.

As further shown, the action frame 291 can be configured to include a corresponding bandwidth request value 299 (numerical value RBVx). A magnitude of the bandwidth request value 299 transmitted in the action frame 291 of the wireless communication 152-X notifies the wireless access point 131 and corresponding communication management resource 141 of the desired bandwidth provided to the mobile communication device 121 over the wireless communication link 171.

Yet further, as discussed below, the communication management resource 141 can be configured to control allocation of wireless bandwidth to the mobile communication device 121 based upon the bandwidth request value 299.

Referring again to FIG. 1, note that the mobile communication device can be configured to retrieve segments of content from the server 195 via use of the corresponding manifest file 121-M. In such an instance, the communication device 121 determines from the manifest file 121-M or other suitable entity of a corresponding bandwidth required to retrieve content from the server 195 at a particular level of quality (a.k.a., bit rate). To support the retrieval of content from the server 195 and ensure proper bandwidth is provided to the communication device 121 by wireless access point 131, the mobile communication device 121 can be configured to notify the wireless access point 131 and corresponding communication management resource 141 of the desired bandwidth (via RBVx) needed to support the retrieval of different segments of content from the server 195 for playback on a corresponding display screen of the mobile communication device 121.

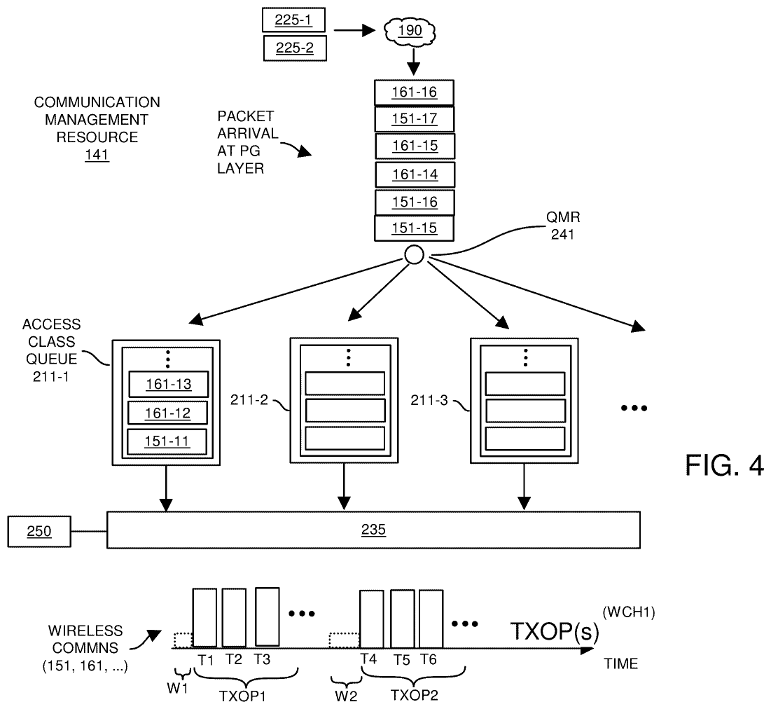

Note that the bandwidth requirements associated with retrieving corresponding content from the server 195 may vary over time. In other words, the communication device 121 may be required to retrieve data at different data bit rates (bits per second) depending upon the type of content retrieved. As previously discussed, the mobile communication device 121 can be configured to repeatedly transmit a bandwidth request value 299 to the wireless access point 131 corresponding communication management resource 141. Accordingly, the communication management resource 141 can be configured to constantly adjust bandwidth allocated for use by other mobile communication devices (such as mobile communication device 122, mobile communication device 123, etc.) such that the mobile communication device 121 is provided the magnitude of bandwidth in the downlink as indicated by request value 299 to retrieve subsequent segments of content from the server 195. The FIG. 4 is an example diagram illustrating implementation of multiple queues to control conveyance of downlink data from the wireless access point to multiple communication devices as discussed herein. Note that control of communications in a respective downlink from the wireless access point 131 to multiple communication devices is shown by way of example only. Techniques herein can be used to control conveyance of communications in the uplink direction from the mobile communication device 121 to the wireless access point 131 as well.

In this example, the applications 225 (one or more different applications such as application 225-1 such as a voice processing application, application 225-2 such as a video processing application, and so on) generates data packets for transmission to the mobile communication device 121, communication device 122, mobile communication device 123, etc.

As previously discussed, the communication management resource 141 receives the respective packets destined for delivery to each of the different communication devices. For example, the communication management resource 141 receives data packets 151-11, 151-15, 151-16, 151-17, etc., for delivery to the communication device 121. Each of these data packets includes a destination network address of XXX1 indicating that the data packets are to be delivered to the corresponding communication device 121. The communication management resource 141 sorts the received data packets and stores them in the different queues depending upon the destination network address indicating the target to which the data packets are directed.

The communication management resource 141 receives data packets 161-12, 161-13, 161-14, 161-15, 161-16, etc., for delivery to the communication device 122. Each of these data packets includes destination network address of XXX2 indicating that the data packets are to be delivered to the corresponding communication device 122.

Assume in this example embodiment, the communication management resource 141 and corresponding queue management resource to 141 stores the received data packets (associated with communication device 121, and communication device 122) in the high priority queue 211-1 because excess bandwidth is available to communicate the data packets to the different mobile communication devices.

Further, as previously discussed, during a condition in which the communication device 121 does not receive downlink wireless bandwidth at a level as indicated by the requested bandwidth value RBV, the communication management resource 141 and corresponding queue management resource 241 can be configured to adjust storage of the received data packets in the different queues 211 in order to provide different levels of wireless bandwidth to the communication device 121, communication device 122, etc.

As further shown, the communication management resource 141 includes the data packet scheduling manager 235. As its name suggests, the data packet scheduling manager 235 implements the corresponding forwarding rules 250 to forward data packets from the queues 211 over the wireless channel WCH1 to the different communication devices. Note further that forwarding of the data packets from the wireless access point 131 over the different wireless communication links includes the wireless access point 131 implementing a so-called listen before talk function as previously discussed to acquire rights to the channel (TXOPs) during which time the wireless access point 131 transmits the corresponding data packets queues 211 to the target communication devices. To acquire the respective wireless channel WCH1, the wireless access point 131 must detect that the wireless energy level associated with wireless channel WCH1 is below a respective threshold level for a time duration W1, time duration W2, etc.

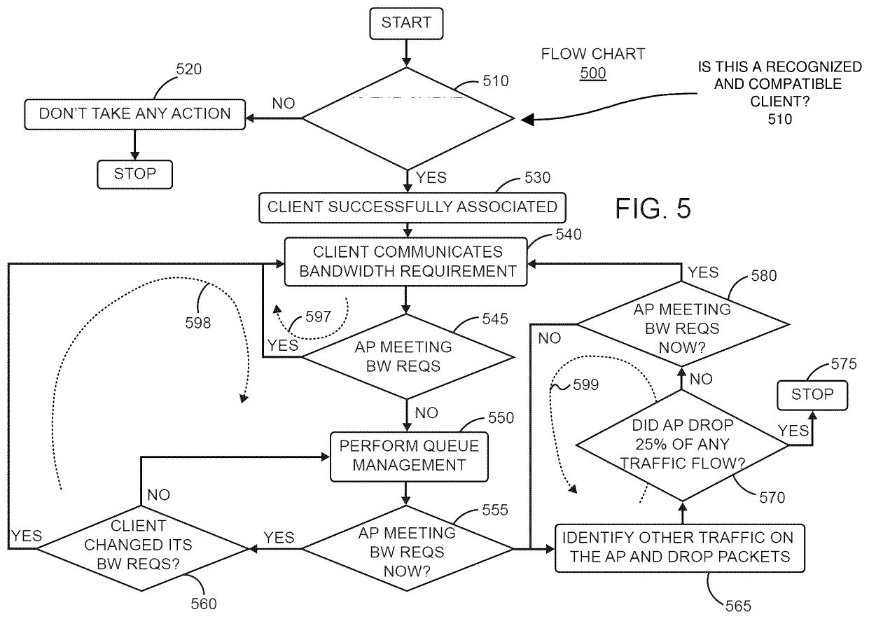

FIG. 5 is an example diagram illustrating a flowchart of controlling bandwidth allocation to multiple communication devices as discussed herein.

In this example, flowchart 500 illustrates operations associated with the communication management resource 141 and providing bandwidth control to multiple communication devices in the network environment 100.

In processing operation 510, the communication management resource receives communications from the mobile communication device 121 indicating a desire to establish a respective wireless communication link 171. Further in processing operation 510, the communication management resource 141 determines whether the client (such as communication device 121 and corresponding user operating the communication device 121) is a subscriber of a service provider network providing wireless services through the wireless access point 131.

If the communication management resource 141 determines in processing operation 510 that the communication device 121 is not authorized (not a subscriber) to use the respective wireless access point 131 and corresponding wireless services, the communication management resource 141 executes the operation 520 of denying the communication device 121 access to the remote network 190 through the wireless access point 131.

Conversely, if the communication management resource determines in processing operation 510 that communication device 121 is authorized (is a subscriber) to use the respective wireless access point 131 and corresponding wireless services, the communication management resource 141 continues executing flow at processing operation 530.

In processing operation 530, such as via association, the wireless access point 131 and the corresponding communication device 121 exchange appropriate communications to set up the wireless communication link 171.

Subsequent to establishing the wireless communication link 171, in processing operation 540, the communication management resource 141 receives communications 152 from the communication device 121. In one example, one or more of the communications 152 received from the communication device 121 indicate a desired downlink bandwidth (as indicated by RBV) to be provided by the wireless access point 131 to the mobile communication device 121.

As previously discussed, each of the communications 152 transmitted from the mobile communication device 121 to the wireless access point 131 can be configured to include a corresponding bandwidth request value (RBV or requested bandwidth value) indicating a magnitude of wireless bandwidth needed or desired by the mobile communication device 131 to retrieve subsequent one or more segments of content from the server 195.

For example, based on the manifest file 121-M, the mobile communication device 121 can be configured to determine that a first magnitude of wireless bandwidth is required to retrieve first one or more segments of the content for a first duration of time. The communication device 121 notifies the wireless access point via RBV1 that the communication device needs the first magnitude of wireless bandwidth for a first time duration.

Based on the manifest file 121-M, the mobile communication device 121 can be configured to determine that a second magnitude of wireless bandwidth is required to retrieve second one or more segments of the content for a second duration of time. The communication device 121 notifies the wireless access point via RBV2 that the communication device needs the second magnitude of wireless bandwidth for a second time duration.

Accordingly, the wireless access point 131 repeatedly transmits communications from the mobile communication device 121 such as RBVx indicating a desired bandwidth for the communication device 121 to receive communications 151 (such as data packets or segments of requested content) from the wireless access point 131.

In one example, the communication management resource 141 produces and keeps track of a respective current bandwidth value CBV indicating the current wireless bandwidth provided by the wireless access point 131 in the downlink to the mobile communication device 121. In processing operation 545, because the communication device 121 is assigned the highest priority level PL1, the communication management resource 141 determines whether or not the mobile communication device 121 is provided an appropriate level of bandwidth to convey communications in the downlink direction from the wireless access point 131 to the mobile communication device 121. Additionally, in processing operation 545, the communication management resource 141 compares the magnitude of the requested bandwidth as indicated by the bandwidth request value RBV to the current bandwidth value CBV.

More specifically, in processing operation 545, if the magnitude of the bandwidth request value RBV (such as received in communications 152) is less than the current bandwidth value CBV, the communication management resource 141 loops back (Luke 597) to executing processing operation 540. In such an instance, because the bandwidth request value RBV is less than the current bandwidth value CBV, there is no need to change the current bandwidth provided to the mobile communication device 121. In other words, the communication device 121 does not need more bandwidth allocated to it.

On the other hand, in processing operation 545, if the magnitude of the bandwidth request value RBV is greater than the magnitude of the current bandwidth value CBV (a.k.a., current bandwidth allocated for use by the mobile communication device 121), the communication management resource 141 continues at processing operation 550. In such an instance, this means that the mobile communication device 121 needs to be allocated additional bandwidth such that the mobile communication device 121 is able to receive data from the wireless access point 131 at a desired bit rate is specified by the received RBV value.

Providing additional allocation of bandwidth to the mobile communication device 121 may occur in any suitable manner. In one example, in response to detecting that the magnitude of the current wireless bandwidth CBV is less than the recently received bandwidth request value RBV, the communication management resource 141 adjusts a queue priority level of storing data packets (associated with delivery to one or more communication devices 121, 122, 123, etc.) in the multiple queues 211. The adjustment of queue priority levels associated with the communications destined to the mobile communication device 121 or other communication devices (including communication device 122, communication device 123, etc.) changes the bandwidth provided to each of the different communication devices. In one example, the adjusted queue priority level of storing the data packets destined for delivery to the first communication device increases a magnitude of the wireless bandwidth to be greater than a magnitude of the bandwidth request value. Additionally, or alternatively, reducing the priority level of storing data packets associated with delivery to the communication devices 122, 123, etc., results in more free bandwidth in which to transmit communications from the queues 211 to the communication device 121.

In further processing operation 555, subsequent to adjusting the queue priority levels associated with communications conveyed to other communication devices 122, 123, etc., the communication management resource 141 determines whether the adjustment to the queue scheduling in processing operation 550 results in providing appropriate additional wireless bandwidth to the mobile communication device 121. More specifically, in processing operation 555, the communication management resource 141 again compares the current bandwidth value CBV to the requested bandwidth value RBV to determine whether or not the needs of the communication device 121 are being met. As previously discussed, the current bandwidth value CBV may increase after either increasing a priority level associated with storing data packets to the communication device 121 in the queues 211 or decreasing the priority level of storing transmitting data packets associated with the communication device 122 from the queues 211. If it is determined that the queue priority modifications as previously discussed results in the current bandwidth value CBV being greater than the requested bandwidth value RBV, then flow continues at processing operation 540 where the communication management resource 141 receives continuous updates of the received requested bandwidth value RBV from the communication device 121.

In processing operation 555, if the wireless access point 131 meets the bandwidth requirements associated with transmitting data to the communication device 121, flow continues at operation 560. In processing operation 560, the communication management resource 141 determines whether the communication device 121 changes in its bandwidth requirements by sending a different value of RBV. If not, processing flow continues at operation 550. Conversely, if the communication device and 21 changes its bandwidth requirements as detected in processing operation 560, flow continues at processing operation 540.

Thus, the loop 598 including flow control operations such as one or more of processing operation 540, processing operation 545, processing operation 550, processing operation 555, etc., can be configured to support providing more bandwidth to support downlink communications from the wireless access point 131 to the mobile communication device 121.

Alternatively, in processing operation 555, if the queue management modifications applied by the communication management resource 141 to the queues 211 in the loop 598 does not or fails to result in the current bandwidth value CBV being increased to a value greater than or equal to the requested bandwidth value RBV, then flow continues at loop 599 and corresponding processing operation 565.

In this example, as further discussed herein, the loop 599 is configured to provide repetitive adjustment of downlink communications of data packets from the wireless access point 131 to the mobile communication device 122, mobile communication device 123, etc. In processing operation 565 of the loop 599, the communication management resource 141 determines data packets received from the network 190 and that are destined for delivery to any communication device other than the communication device 121.

For example, the communication management resource 141 can be configured to determine data packets destined for delivery to the communication device 122. Further, in processing operation 565, the communication management resource 141 drops delivery of data packets destined for delivery to the communication device 122. In one example, the communication management resource 141 starts by dropping 10 percent of the data packets destined for delivery to the communication device and allows 90 percent of the data packets to be delivered to the communication device 122. Flow control continues at processing operation 570. The communication management resource 141 keeps track of the reduction of bandwidth to the communication device 122 by storing an indication of dropping 10 percent of the data packets to the communication device 122.

In further processing operation 570, the communication management resource determines whether the magnitude of currently drop packets (now 10 percent) exceeds a respective threshold level such as 25 percent. If so, processing operation discontinues at operation 575 where the communication management resource 141 exits the corresponding loop 599.

Alternatively, in this example, the communication management resource 141 detects that the magnitude (10 percent) of currently dropped data packets associated with the communication device 122 is less than the threshold drop level of 25 percent. In such an instance, the communication management resource 141 continues execution of the flowchart 500 at processing operation 580.

The reduction of wireless bandwidth supporting conveyance of data packets from the wireless access point 131 to the mobile communication device 122 increases the magnitude of bandwidth available and provided to the communication device 121. This means that the communication management resource 141 updates the current bandwidth value CBV to indicate the increased bandwidth provided to the mobile communication device 121. In processing operation 580, the communication management resource 141 determines if the current bandwidth value CBV after dropping 10 percent of packets to the communication device 122 is greater than the requested bandwidth value RBV. If so, this means that the communication device 121 is provided the requested bandwidth RBV and processing continues at operation 540. In such an instance, the communication management resource 140 exits the loop 599 to operation 540.

Alternatively, if the 10 percent drop packets associated with delivery to the communication device 122 results in an updated current bandwidth value CBV associated with the communication device 2021 as being less than the requested bandwidth value RBV, then the communication management resource 141 continues at processing operation 565.

In processing operation 565, the communication management resource 141 drops delivery of data packets destined for delivery to the communication device 122. In one example, the communication management resource 141 drops an additional 10 percent of the data packets (such that the total drop of data packets to the communication device 122 is 20 percent) destined for delivery to the communication device and allows 80 percent of the data packets to be delivered to the communication device 122. Flow control continues at processing operation 570. The communication management resource 141 keeps track of the reduction of bandwidth to the communication device 122 by storing an indication of dropping 20 percent of the data packets.

In further processing operation 570, the communication management resource determines whether the magnitude of currently drop packets (now 20 percent) exceeds a respective threshold level such as 25 percent. If so, processing operation discontinues at operation 575 where the communication management resource 141 exits the corresponding loop 599.

Alternatively, in this example, the communication management resource 141 detects that the magnitude (20 percent) of currently dropped data packets associated with the communication device 122 is less than the threshold drop level of 25 percent. In such an instance, the communication management resource 141 continues execution of the flowchart 500 at processing operation 580.

The reduction of wireless bandwidth supporting conveyance of data packets from the wireless access at 131 to the mobile communication device 122 increases the magnitude of bandwidth provided to the communication device 121. This means that the communication management resource 141 updates the current bandwidth value CBV to indicate the increased bandwidth provided to the mobile communication device 121. In processing operation 580, the communication management resource 141 determines if the current bandwidth value CBV is now greater than the requested bandwidth value RBV. If so, this means that the communication device 121 is provided the requested bandwidth RBV and processing continues at operation 540. In such an instance, the communication management resource 140 exits the loop 599 to processing operation 540.

Alternatively, if the 20 percent drop packets associated with delivery to the communication device 122 results in an updated current bandwidth value CBV that is still less than the requested bandwidth value RBV, then the communication management resource 141 continues at processing operation 565 again. In such an instance, process flows as previously discussed until the number of dropped data packets to the communication device 121 is greater than the threshold level of 25 percent. This protects the communication device 122 such that receives at least some data packets destined for delivery to it.

Accordingly, each iteration of the loop 599 provides additional downlink resources (bandwidth) based on dropped wireless bandwidth to the communication device 122 in which to increase the magnitude of the current bandwidth value CBV to be greater than the most recent received requested bandwidth value RBV.

In other words, via the loop 599, adjustment of the magnitude of the current wireless bandwidth (such as CBV) supplied to the first communication device 121 may include: via a first loop 599 and corresponding communication management resource 141, iteratively adjusting the magnitude of second wireless bandwidth allocated to support wireless connectivity between the wireless access point 131 and a second mobile communication device 122. The iterative adjustment of the magnitude of the second wireless bandwidth to the mobile communication device 122 includes: iteratively reducing a magnitude of the second wireless bandwidth; and using freed up bandwidth associated with the reduction of the magnitude of the second wireless bandwidth (applied to the mobile communication device 122) to support an increase in the wireless bandwidth provided to the communication device 121.

The above example indicates to iteratively reduce wireless bandwidth supplied to the mobile communication device 122 in order to free up wireless bandwidth for use by the mobile communication device 121. Note that the iterative reduction of bandwidth associated with the loop 599 may include simultaneously dropping packets associated with multiple communication devices for each implementation of the operations associated with the loop 599.

For example, in such an instance, the communication management resource 141 can be configured to detect that the current wireless bandwidth supplied to the mobile communication device 121 is less than the requested bandwidth value. Via loop 599, the communication management resource 141 can be configured to repeatedly and simultaneously drop (on each pass) 10 percent or other suitable amount of wireless packets destined for delivery to the multiple mobile communication devices including the mobile communication device 122 and mobile communication device 123. As previously discussed, this reduction in wireless bandwidth to mobile communication device 122 and mobile communication device 123 is then used to support increased wireless bandwidth to a mobile communication device 121.

As a more specific example, if desired, in processing operation 565 of flowchart 500, the communication management resource 141 identifies wireless bandwidth supplied to mobile communication device 122 and mobile communication device 123 (and potentially other communication devices) and simultaneously drops data packets destined for delivery to those multiple mobile communication devices such as mobile communication device 122, mobile communication device 123, etc. The communication management resource keeps track of the 10 percent reduction in processing operation 565. As previously discussed, the reduced bandwidth is then available for use by the mobile communication device 121. In subsequent processing operation 570, the communication management resource 141 detects that the wireless access point 131 has not dropped more than 25 percent of any traffic flow and proceeds to processing operation 580 (10 percent is less than 25 percent). If the reduction in bandwidth (based on dropped packets) supplied to the mobile communication device 122, 123, etc., does not result in the mobile communication device 121 receiving bandwidth above the amount as specified by the bandwidth request value, the communication management resource 141 continues at processing operation 565 again.

In processing operation 565 of flowchart 500, the communication management resource identifies wireless bandwidth supplied to mobile communication device 122 and mobile communication device 123 and further simultaneously drops data packets destined for delivery to multiple mobile communication devices such as mobile communication device 122, mobile communication device 123, etc. As previously discussed, the reduced bandwidth (based on dropping of another 10 percent of data packets for a total of 20 percent dropped for each flow) is then available for use by the mobile communication device 121. The communication management resource 141 keeps track of the total 20 percent dropping of data packets for each data flow. In processing operation 570, the communication management resource 141 detects that the wireless access point 131 has not dropped more than 25 percent of any traffic flow and proceeds to processing operation 580 (in other words, 20 percent is less than the 25 percent threshold). If the reduction in bandwidth (10% magnitude of dropped data packets) supplied to the mobile communication device 122, 123, etc., does not result in the mobile communication device 121 receiving bandwidth above the amount of specified by the bandwidth request value, processing continues operation 565 again.

In processing operation 565 of flowchart 500, the communication management resource identifies wireless bandwidth supplied to mobile communication device 122 and mobile communication device 123 and further simultaneously drops another 10 percent of data packets destined for delivery to multiple mobile communication devices such as mobile communication device 122, mobile communication device 123, etc. As previously discussed, the reduced bandwidth is then available for use by the mobile communication device 121. The communication management resource 141 keeps track of the total 30 percent dropping of data packets. In processing operation 570, the communication management resource detects that the wireless access point 131 has dropped more than 25 percent of any traffic flow and proceeds to processing operation 575 (in other words, 30 percent is greater than 25 percent). In such an instance, the communication management resource 141 discontinues loop 599 at processing operation 575. This determination of dropping of data packets to each of the other communication devices 122, 22, etc., ensures that the bandwidth supplied to the communication device 122, communication device 123, etc., is not so low that those devices have poor wireless access.

In further examples, note that the communication management resource 141 or other suitable entity can be configured to identify TCP similar QoS traffic flows and if there are ‘n’ communication devices and corresponding data flows identified, then pick one communication device and iteratively reduce bandwidth by a predetermined amount such as 10 percent or any other suitable amount. If the reduction associated with dropping packets for one communication device doesn't result in an increase in a magnitude of the wireless bandwidth supplied to the mobile communication device 121 above the requested amount, then the communication management resource 141 selects another communication device supported by the wireless access point 131 and reduces a magnitude of bandwidth supplied to the second mobile communication device to free of bandwidth for use by the mobile communication device 121. This can be repeated for each of the communication device flows until the bandwidth requirement for the communication device 121 is achieved. If the sequential single reduction in bandwidth provided to the multiple communication devices does not result in the desired bandwidth to the communication device 121 on a first pass of loop 599, then the communication management resource 141 repeats applying sequential reduction in bandwidth for each of the communication data flows until the appropriate bandwidth is available for the communication device 121 or after a threshold amount of 25% reduction is applied to each of the communication devices other than communication device 121. A further example of sequentially reducing bandwidth to each of multiple communication devices to increased bandwidth to the mobile communication device 121 is discussed below.

More specifically, the communication management resource 141 can be configured to adjust the magnitude of the current wireless bandwidth allocated to the first communication device 121 including, on a first pass of loop 599, reducing a magnitude of second wireless bandwidth allocated (to the mobile communication device 122) to support wireless connectivity between the wireless access point and a second mobile communication device 122. The reduction in the magnitude of the second wireless bandwidth (such as by the communication management resource 141 dropping 10 percent of data packets destined for delivery to the mobile communication device 122) increases the magnitude of the current wireless bandwidth allocated to the first communication device 121. If this dropping of data packets to the mobile communication device 122 is not result in sufficient wireless bandwidth supplied to the mobile communication device 121, the communication management resource 141 executes the loop 599 again for another indication device. For example, on a second pass of executing the loop 599, adjustments of the bandwidth supplied to the mobile communication device 121 by the communication management resource 141 includes the communication management resource 141 reducing (such as by the communication management resource 141 dropping 10 percent of data packets destined for delivery to the mobile communication device 123) a magnitude of the third wireless bandwidth allocated to support wireless connectivity between the wireless access point and a third mobile communication device 123 in response to detecting that the current wireless bandwidth allocated to the first communication device is less than the bandwidth request value subsequent to reducing the magnitude of the second wireless bandwidth supplied to the second mobile communication device 122. This second pass of executing loop 599 and reducing the magnitude of the third wireless bandwidth increases the magnitude of the current wireless bandwidth allocated to the first communication device.

The communication management resource 141 can be configured to repeat execution of the loop 599 for each of multiple communication devices other than the mobile communication device 121 until the communication management resource 141 drops 10 percent of data packets for each of the communication devices other than the mobile communication device 121. As previously discussed, the communication management resource 141 can be configured to prevent dropping of data packets for each of the communication devices from being greater than 25 percent on any data traffic flow. Thus, the communication management resource 141 can be configured to prevent the magnitude of the second wireless bandwidth allocated to the mobile communication device 122 from dropping below a first threshold level; the communication management resource 141 can be figured to prevent the magnitude of the third wireless bandwidth allocated to the mobile communication device 123 dropping below a second threshold level; and so on.

After the communication management resource 141 completes dropping 10 percent of data packets for each of the communication devices other than communication device 121, the communication management resource 141 can be configured to sequentially drop another 10 percent of data packets to each of the communication devices other than the communication device 121 to free up and with for use by the communication device 121. At any point, if the communication management resource 141 detects that the communication device 121 has sufficient wireless bandwidth, the communication management resource 141 and the configured to discontinue dropping additional data packets because it is not necessary.

Accordingly, adjustment of the wireless bandwidth as discussed herein can be configured to include the communication management resource 141 reducing a magnitude of second wireless bandwidth allocated to support wireless connectivity between the wireless access point and multiple communication devices (such as including a second mobile communication device 122, a third mobile communication device 123, etc.). The reduction in the magnitude of the second wireless bandwidth (via simultaneous dropping of data packets associated with multiple communication devices) increases the magnitude of the current wireless bandwidth allocated to the first communication device 121. Further, adjustment of the magnitude of the current wireless bandwidth allocated to the first communication device 121 may further include the communication management resource 141 further reducing (such as via further dropping of packets) a magnitude of second wireless bandwidth allocated to support wireless connectivity between the wireless access point and multiple communication devices in response to detecting that the current wireless bandwidth allocated to the first communication device 121 is less than the bandwidth request value subsequent to reducing the magnitude of the second wireless bandwidth. The further reduction (based on dropping of data packets) in the magnitude of the second wireless bandwidth increases the magnitude of the current wireless bandwidth allocated to the first communication device.

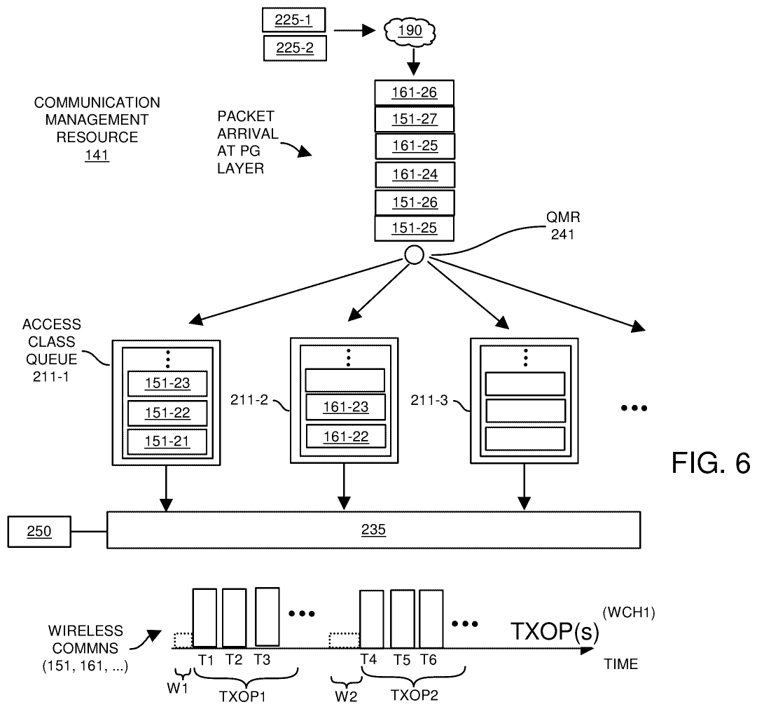

FIG. 6 is an example diagram illustrating implementation of a communication management resource to adjust communication of data packets to multiple communication devices as discussed herein.

In this example, via loop 598 of flowchart 500, in a manner as previously discussed, the communication management resource 141 adjusts the corresponding priority level of storing data packets destined for one or more of the communication device 122, communication device 123, etc., to free up bandwidth for use by the communication device 121.

More specifically, the communication management resource 141 can be configured to initially store data packets destined for the communication device 122 in the high priority access class queue 211-1 in a manner as previously discussed prior to detecting that the communication device 121 needs more wireless bandwidth.

In response to the communication management resource 141 detecting that the communication device 121 needs more wireless bandwidth (RBV>CBV), the communication management resource 141 can be configured to store data packets destined for the communication device 122 in the corresponding lower priority queue 211-2 instead of queue 211-1. Alternatively, if the queue management resource was previously storing data packets destined for the communication device 122 in the queue 211-2 prior to the communication device 121 needing more wireless bandwidth, the communication management resource 141 can be configured to store data packets destined for the communication device 122 in the corresponding lower priority queue 211-3 instead of queue 211-2. Storing the data packets in the lower priority queues result in lower bandwidth provided to those communication devices.

According to the forwarding rules 250, the data packet scheduling manager 235 transmits the data packets 151-21, 151-22, 151-23, etc., in the access class queue 211-1 to the communication device 121. The data packet scheduling manager 235 transmits the data packets 161-21, 161-22, 161-23, etc., in the access class queue 211-2 at a slower rate to the communication device 122 than transmission of the data packets in queue 211-1 to the communication device 121. Storing and transmitting the data packets 161 from the lower priority queue 211-2 or queue 211-3 results in freeing up the queue 211-1 to store and transmit more data packets from the wireless access point 131 to the communication device 121. In other words, as previously discussed, storing the data packets associated with the communication device 122, communication device 123, etc., and the lower priority queues results and an increase in wireless bandwidth allocated to the communication device 121.

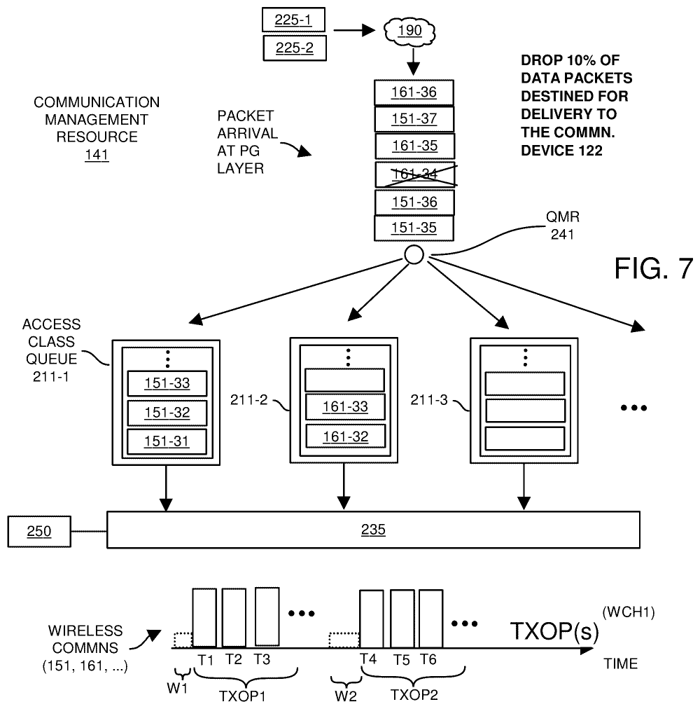

FIG. 7 is an example diagram illustrating implementation of first level data packet dropping associated with communicating data in a downlink to one or more communication devices to provide increased bandwidth to a higher priority communication device as discussed herein.

As previously discussed in the flowchart 500, the communication management resource 141 can be configured to repeatedly execute the loop 599 and corresponding processing operations to reduce the wireless bandwidth provided by the wireless access point 131 to the communication device 122 and other communication devices 123, etc., in response to a respective condition in which the current bandwidth value CBV associated with the communication device 121 is less than the recently received requested bandwidth value RBV provided by the communication device 121.

In this example as shown in FIG. 7, the communication management resource 141 reduces the bandwidth provided to the communication device 122 by dropping 10% of the data packets received from network 190 and destined for delivery by the wireless access point 131 to the communication device 122. As shown, the 10 percent of dropped data packets destined for delivery to the communication device 122 include data packet 161-34.

More specifically, assume that the communication management resource 141 receives the corresponding data packets 161-32, 161-33, 161-34, 161-35, 161-36, etc., for delivery over the wireless communication link 172 to the communication device 122. In order to reduce the amount of wireless bandwidth provided to the communication device 122, as previously discussed, the communication management resource 141 and corresponding queue management resource 241 can be figured to drop 10 percent of the data packets destined for delivery to the communication device 122. As previously discussed, this includes dropping data packet 161-34 such that the data packet is not delivered over the wireless communication link 172 to the communication device. The data packets being dropped can be dropped from a respective one or more of the queues 211 or the incoming received data packets.

In one example, the dropping of the data packets results in freeing wireless bandwidth for use by the wireless access point 131 to communicate data packets 151-31, 151-32, 151-33, 151-34, etc., to the communication device 121. The dropping of the data packets may cause the transmitting communication device such as server 195 to throttle back future transmission of data packets to the communication device 122, reducing wireless bandwidth to communicate data packets to the communication device 122.

Thus, the freed up bandwidth associated with the reduction of the magnitude of the second wireless bandwidth (dropping up 10 percent of the data packets destined for delivery to the communication device 122) supports an increase in the first wireless bandwidth.

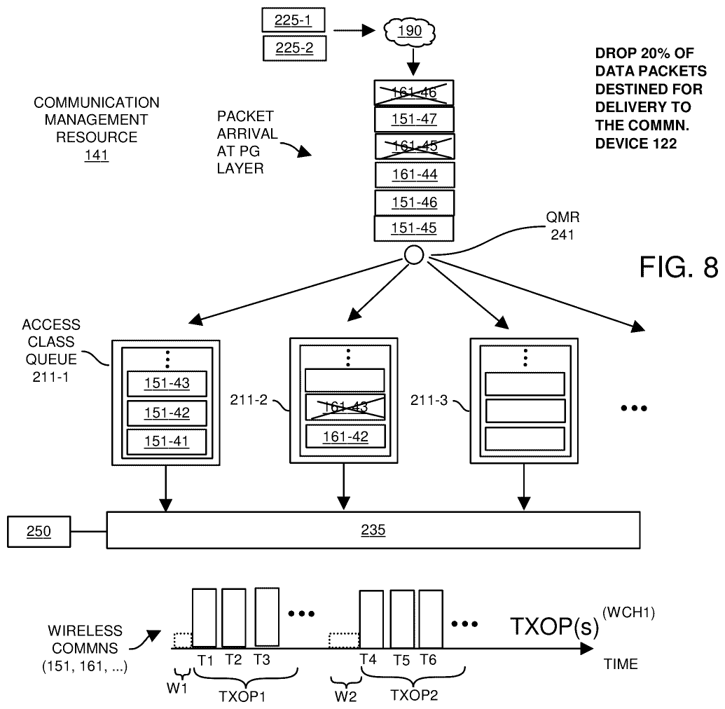

FIG. 8 is an example diagram illustrating implementation of second level data packet dropping associated with communicating data in a downlink to one or more communication devices to provide increased bandwidth to a higher priority indication device as discussed herein.

As previously discussed in the flowchart 500, the communication management resource 141 repeatedly executes the loop 599 and corresponding processing operations to reduce the wireless bandwidth provided by the wireless access point 131 to the communication device 122 in response to a respective condition in which the recently received current bandwidth value CBV associated with the communication device 121 is less than the requested bandwidth value RBV provided by the communication device 121.

In this example as shown in FIG. 8, the communication management resource 141 reduces the bandwidth provided to the communication device 122 by dropping 20% of the data packets received from network 190 and destined for delivery by the wireless access point 131 to the communication device 122.

More specifically, assume that the communication management resource 141 receives the corresponding data packets 161-42, 161-43, 161-44, 161-45, 161-46, etc., for delivery over the wireless communication link 172 to the communication device 122. In order to reduce the amount of wireless bandwidth provided to the communication device 122, as previously discussed, the communication management resource 141 and corresponding queue management resource 241 can be figured to drop 20 percent of the data packets destined for delivery to the communication device 122. The data packets being dropped can be dropped from a respective one or more of the queues 211 or the incoming received data packets.

In one example, the dropping of the data packets (such as in a packets 161-43, 161-45, 161-46, etc.) results in freeing wireless bandwidth for use by the wireless access point 131 to communicate data packets 151-41, 151-42, 151-43, 151-44, etc., to the communication device 121. The dropping of the data packets may cause the transmitting communication device such as server 195 to throttle back future transmission of data packets to the communication device 122.

Thus, the freed up bandwidth associated with the reduction of the magnitude of the second wireless bandwidth (dropping up 20 percent of the data packets destined for delivery to the communication device 122) supports an increase in the current wireless bandwidth (CBV) provided to the communication device 121.

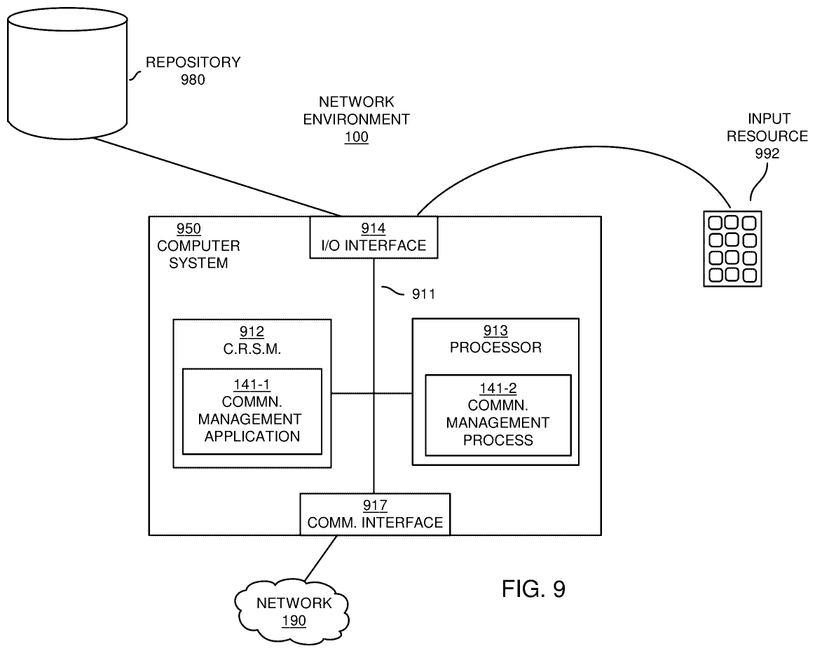

FIG. 9 is an example block diagram of a computer system for implementing any of the operations as previously discussed according to examples herein.

Any of the resources (such as wireless stations, communication management resource associated with wireless access point 131, communication management resource associated with mobile communication device 121, wireless access point 131, mobile communication device 121, communication management resource 141, data packet scheduling manager, etc.) as discussed herein can be configured to include computer processor hardware and/or corresponding executable instructions to carry out the different operations as discussed herein via computer system 950.

As shown, computer system 950 of the present example includes an interconnect 911 coupling computer readable storage media 912 such as a non-transitory type of media or, more generally, computer readable hardware which can be any suitable type of hardware storage medium in which digital information can be stored and retrieved, a processor 913 (computer processor hardware), I/O interface 914, and a communications interface 917.

I/O interface(s) 914 supports connectivity to repository 980 and input resource 992.

Computer readable storage medium 912 (such as computer readable hardware or other suitable entity) can be any hardware storage device such as memory, optical storage, hard drive, floppy disk, etc. In one example, the computer readable storage medium 912 stores instructions and/or data.

As shown, computer readable storage media 912 can be encoded with communication management application 141-1 (e.g., including instructions) to carry out any of the operations as discussed herein.

During operation of one example, processor 913 accesses computer readable storage media 912 via the use of interconnect 911 in order to launch, run, execute, interpret or otherwise perform the instructions in communication management application 141-1 stored on computer readable storage medium 912. Execution of the communication management application 141-1 produces the communication management process 141-2 to carry out any of the operations and/or processes as discussed herein.

Those skilled in the art will understand that the computer system 950 can include other processes and/or software and hardware components, such as an operating system that controls allocation and use of hardware resources to execute the communication management application 141-1.

In accordance with different examples, note that computer system may reside in any of various types of devices, including, but not limited to, a mobile computer, a personal computer system, wireless station, connection management resource, a wireless device, a wireless access point, a access point, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 950 may reside at any location or can be included in any suitable resource in any network environment to implement functionality as discussed herein. In one example, the control system 950 can include or be implemented in virtualization environments such as the cloud.

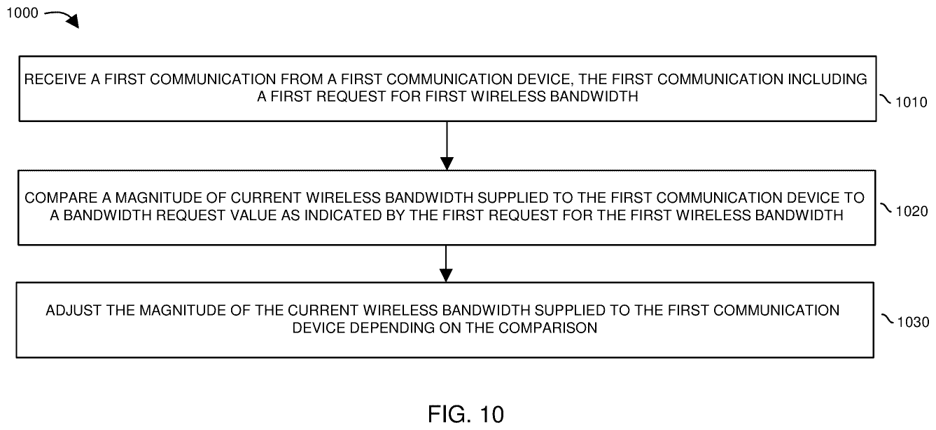

Functionality supported by the different resources will now be discussed via flowchart in FIG. 10. Note that the steps in the flowcharts below can be executed in any suitable order.

FIG. 10 is a flowchart 1000 illustrating an example method according to examples. Note that flowchart 1000 overlaps/captures general concepts as discussed herein.

In processing operation 1010, the communication management resource 141 receives a first communication from a first communication device 121. The first communication includes a first request for first wireless bandwidth.

In processing operation 1020, the communication resource 141 compares a magnitude of current wireless bandwidth supplied to the first communication device to a bandwidth request value as indicated by the first request for the first wireless bandwidth.

In processing operation 1030, the communication management resource adjusts the magnitude of the current wireless bandwidth supplied to the first communication device based on the comparison.

Note again that techniques herein are well suited to facilitate selection of a corresponding wireless security protocol to support wireless communications between a first wireless station and a second wireless station. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
via a wireless access point:
receiving a first communication from a first communication device, the first communication including a first request for first wireless bandwidth;
comparing a magnitude of current wireless bandwidth allocated to the first communication device to a bandwidth request value as indicated by the first request; and
adjusting the magnitude of the current wireless bandwidth allocated to the first communication device based on the comparison.

2. The method as in claim 1, wherein adjusting the magnitude of the current wireless bandwidth allocated to the first communication device includes:
via a first loop, iteratively adjusting a magnitude of second wireless bandwidth allocated to support wireless connectivity between the wireless access point and a second mobile communication device.

3. The method as in claim 2, wherein iteratively adjusting the magnitude of the second wireless bandwidth includes:
iteratively reducing the magnitude of the second wireless bandwidth allocated to the second mobile communication device; and
using freed up bandwidth associated with the reduction of the magnitude of the second wireless bandwidth to support an increase in the current wireless bandwidth allocated to the first communication device.

4. The method as in claim 1 further comprising:
in response to detecting that the magnitude of the current wireless bandwidth allocated to the first communication device is less than the bandwidth request value, adjusting a queue priority level of storing data packets in multiple queues, the stored data packets destined for delivery to the first communication device.

5. The method as in claim 4, wherein the adjusted priority level of storing the data packets destined for delivery to the first communication device increases a magnitude of the current wireless bandwidth to be greater than a magnitude of the bandwidth request value.

6. The method as in claim 1 further comprising:
receiving the bandwidth request value in an action frame of the first communication.

7. The method as in claim 1 further comprising:
receiving the first communication over a first wireless communication link from the first communication device; and
via the current wireless bandwidth, providing the first communication device access to a remote network through the wireless access point.

8. The method as in claim 1 further comprising:
determining that the first communication device is assigned a first priority level; and
increasing a magnitude of the current wireless bandwidth allocated to the first communication device in response to detecting that the first priority level assigned to the first communication device is higher than a second priority level assigned to a second communication device provided wireless access to a remote network through the wireless access point.

9. The method as in claim 8, wherein the increased magnitude of the current wireless bandwidth supplied to the first communication device is achieved by reducing a magnitude of second wireless bandwidth allocated to the second communication device through the wireless access point.

10. The method as in claim 9, wherein adjusting the magnitude of the current wireless bandwidth allocated to the first communication device includes:
using freed up bandwidth associated with the reduction of the magnitude of the second wireless bandwidth to support an increase in the current wireless bandwidth allocated to the first communication device.

11. A system comprising:
communication management hardware associated with a wireless access point, the communication management hardware operative to:
receive a first communication from a first communication device, the first communication including a first request for first wireless bandwidth;
compare a magnitude of current wireless bandwidth supplied to the first communication device to a bandwidth request value as indicated by the first request; and
adjust the magnitude of the current wireless bandwidth supplied to the first communication device based on the comparison.

12. The system as in claim 11, wherein the communication manager hardware is further operative to:
via a first loop, iteratively adjust a magnitude of second wireless bandwidth allocated to support wireless connectivity between the wireless access point and a second mobile communication device.

13. The system as in claim 12, wherein the communication manager hardware is further operative to:
iteratively reduce the magnitude of the second wireless bandwidth; and
use freed up bandwidth associated with the reduction of the magnitude of the second wireless bandwidth to support an increase in the current wireless bandwidth allocated to the first communication device.

14. The system as in claim 11, wherein the communication manager hardware is further operative to:
in response to detecting that the magnitude of the current wireless bandwidth allocated to the first communication device is less than the bandwidth request value, adjust a queue priority level of storing data packets in multiple queues, the stored data packets destined for delivery to the first communication device.

15. The system as in claim 14, wherein the adjusted priority level of storing the data packets destined for delivery to the first communication device increases a magnitude of the current wireless bandwidth to be greater than a magnitude of the bandwidth request value.

16. The system as in claim 11, wherein the communication manager hardware is further operative to:
receive the bandwidth request value in an action frame of the first communication.

17. The system as in claim 11, wherein the communication manager hardware is further operative to:
receive the first communication over a first wireless communication link from the first communication device; and
via the current wireless bandwidth, provide the first communication device access to a remote network through the wireless access point.

18. The system as in claim 11, wherein the communication manager hardware is further operative to:
determine that the first communication device is assigned a first priority level; and
increase a magnitude of the current wireless bandwidth allocated to the first communication device in response to detecting that the first priority level assigned to the first communication device is higher than a second priority level assigned to a second communication device will provided wireless access to a remote network through the wireless access point.

19. The system as in claim 18, wherein the increased magnitude of the current wireless bandwidth supplied to the first communication device is achieved by reducing a magnitude of second wireless bandwidth allocated to the second communication device through the wireless access point.

20. The system as in claim 19, wherein the communication manager hardware is further operative to:
use freed up bandwidth associated with the reduction of the magnitude of the second wireless bandwidth to support an increase in the current wireless bandwidth allocated to the first communication device.

21. Computer-readable storage hardware having instructions stored thereon, the instructions, when carried out by computer processor hardware of a wireless access point, cause the computer processor hardware to:
receive a first communication from a first communication device, the first communication including a first request for first wireless bandwidth;
compare a magnitude of current wireless bandwidth supplied to the first communication device to a bandwidth request value as indicated by the first request for the first wireless bandwidth; and
adjust the magnitude of the current wireless bandwidth supplied to the first communication device based on the comparison.

22. The method as in claim 1, wherein adjusting the magnitude of the current wireless bandwidth allocated to the first communication device includes:
reducing a magnitude of second wireless bandwidth allocated to support wireless connectivity between the wireless access point and a second mobile communication device, the reduction in the magnitude of the second wireless bandwidth increasing the magnitude of the current wireless bandwidth allocated to the first communication device.

23. The method as in claim 22, wherein adjusting the magnitude of the current wireless bandwidth allocated to the first communication device further includes:
in response to detecting that the current wireless bandwidth allocated to the first communication device is less than the bandwidth request value subsequent to reducing the magnitude of the second wireless bandwidth, reducing a magnitude of the third wireless bandwidth allocated to support wireless connectivity between the wireless access point and a third mobile communication device, the reduction in the magnitude of the third wireless bandwidth increasing the magnitude of the current wireless bandwidth allocated to the first communication device.

24. The method as in claim 23 further comprising:
preventing the magnitude of the second wireless bandwidth from dropping below a first threshold level; and
preventing the magnitude of the third wireless bandwidth from dropping below a second threshold level.

25. The method as in claim 1, wherein adjusting the magnitude of the current wireless bandwidth allocated to the first communication device includes:
reducing a magnitude of second wireless bandwidth allocated to support wireless connectivity between the wireless access point and multiple communication devices including a second mobile communication device and a third mobile communication device, the reduction in the magnitude of the second wireless bandwidth to the second mobile communication device and the third mobile communication device increasing the magnitude of the current wireless bandwidth allocated to the first communication device.

26. The method as in claim 25, wherein adjusting the magnitude of the current wireless bandwidth allocated to the first communication device further includes:
in response to detecting that the current wireless bandwidth allocated to the first communication device is less than the bandwidth request value subsequent to reducing the magnitude of the second wireless bandwidth, further reducing a magnitude of the second wireless bandwidth allocated to support wireless connectivity between the wireless access point and multiple communication devices, the further reduction in the magnitude of the second wireless bandwidth increasing the magnitude of the current wireless bandwidth allocated to the first communication device.
